(19) United States
(12) Patent Application Publication
(10) Pub. No.: US 2015/0157145 A1
(43) Pub. Date: Jun. 11, 2015

(54) GREETING CARD DISTRIBUTION SYSTEM

(71) Applicant: TAPGREET, INC., San Rafael, CA (US)

(72) Inventor: Paul Bussi, San Rafael, CA (US)

(21) Appl. No.: 14/394,053

(22) PCT Filed: Apr. 9, 2013
(86) PCT No.: PCT/US2013/035808

§ 371 Date: Oct. 10, 2014

Related U.S. Application Data
(60) Provisional application No. 61/622,322, filed on Apr. 10, 2012.

(51) Int. Cl. A47F 7/14; G06Q 30/06; B42D 15/02

(52) U.S. Cl. CPC A47F 7/146; B42D 15/02; G06Q 30/0643

(57) ABSTRACT

A greeting card distribution system comprises a display (20) where the cards (27) are positioned in pockets (26) edgewise so that no more than 20% of the front face (82) of the cards (27) is visible to increase the density of cards (27) that can be sold in a limited retail space. The images of the cards (27) in the display (20) can be viewed on a client device (204). A customer can be provided a location code (92) for a purchased card, and can then remove the card from the pocket (26) associated with the location code (92). Preferably the display (20) has multiple replaceable modules (24) so that cards (27) can be restocked or changed out in bulk by removing a replaceable module (24) and replacing it with another module (24) already stocked with cards (27).

### CROSS-REFERENCE TO RELATED APPLICATIONS

The present application is a PCT Patent Application titled “Greeting Card Distribution System,” and claims the benefit of U.S. Provisional Patent Application 61/622,322, the contents of which are incorporated in this disclosure by reference in their entirety.

### BACKGROUND

Greeting cards are typically displayed in racks having one of two primary configurations. The first is a “tiered” display unit having parallel rows of pockets or channels into which greetings cards are placed. The channels can have a depth less than the height of the cards to be displayed therein, thereby enabling a prospective customer to view a substantial portion of the card. The second primary type of display is known as a “spinner.” Spinners are cylindrical, rotatably mounted display units that have a plurality of card receptacles disposed around their periphery. In both the Tiered and Spinner display units, greeting cards are generally displayed face forward in an upwardly facing pocket so a potential purchaser can view the greeting card. A problem with this type of display is it requires a large amount of retail space to have a comprehensive selection of greeting cards. Since retail space is expensive and often measured by profit per square foot, retailers constantly try to maximize the number of greeting cards displayed per square foot in an attempt to make up for their relatively low price point compared to other products being sold. Moreover, many retail shops with a small amount of retail space and high foot traffic, such as coffee shops, are not suitable for large greeting card displays.

Attempts to overcome this problem involve various designed spinner display units that strive to maximize the number of cards displayed per square foot. However, in practice, many retailers cannot place a spinner display unit in the middle of an aisle because they can interfere with foot traffic while in a retail store. Moreover, spinner displays are often no more efficient at displaying greeting cards than a tiered display unit, they are just more suitable for certain retail environments.

Another problem associated with conventional greeting card display units is they are costly and time consuming to keep stocked and organized. Stocking and organization is required when the overall card inventory starts to become depleted, when cards become displaced due to customer browsing, and when some cards are no longer relevant because they are just seasonal, for events such as Mother's Day, Easter, and Christmas. Considering that many retailers need restocking personnel to replace and organize their greeting card selection nightly, this is a considerable to expense to the overall sale of greeting cards.

Accordingly, there is a need for a greeting card distribution system that utilizes a reduced amount of floor space compared to conventional Tiered and Spinner displays and allows for lower costs and increased efficiency in card stocking and organizing

### SUMMARY

A greeting card display system according to the present invention satisfies this need. The display system includes a novel type of greeting card display, as well as an integrated purchase and restocking system that provides reduced stocking and card organization costs and reduced floor space requirements.

The display comprises at least three pockets, each pocket having a top wall, a bottom wall, opposed side walls, and a generally forward facing opening. There are at least two greeting cards in at least some of the pockets. As usual, the greeting cards have a width, height, a front face, and an edge. However, unlike conventional displays, the greeting cards are positioned in the pockets so the edge faces toward the forwardly facing opening so that no more than 20% of the front face of each card is visible. The pockets can be designed so that substantially none of the front faces of the cards are visible. Even though the cards are not visible to a prospective purchaser, the distribution system, described below, still allows the purchaser to view the image that is on the card and purchase it. With regard to the pockets, the distance between first and second walls, typically the bottom and top walls, is h and the distance between third and fourth walls, which is typically the side walls, is w. Because the cards are in the pockets with the edge facing toward the forward facing opening, the width of at least some of the cards is greater than at least one of w and h.

The pockets can be provided with a location code, as described below, or alternatively a light or other indicia, as used and described below.

Preferably the pockets have a longitudinal access skewed relative to the horizontal surface on which a user/customer is positioned.

The display can be supported on a floor, a wall, a generally vertically oriented post, or a generally horizontally oriented post. The pockets can be stacked relative to each other so that only a portion of adjacent pockets are side by side with each other.

Preferably the display has at least one removable installed module, and preferably multiple such models, where each module has multiple pockets. The system includes a replacement module having the same size and configuration as the removable installed module where the replacement module has a plurality of pockets preloaded with greeting cards. To restock cards, all that is required is to remove the installed module from the display and replace it with the pre-stocked replacement module.

So that a potential customer can view the available stock of greeting cards, the system includes an electronic device having an input interface and a display. The electronic device is enabled to display images of the greeting cards, where at least some of the greeting cards have associated with them a corresponding location code. The device can be enabled to effect purchase of the greeting cards. For example the user can view the greeting cards in the electronic device display, communicate with a host device which can receive a request to purchase the greeting card, provide to the customer the location code of a selected greeting card, and also process the purchase request. Armed with the location code, the user can remove or retrieve the card from the display. Rather than a location code, a signal can be sent to the display to light up the light associated with a pocket or other visual indicator to the customer.

The user can communicate with the host device through the World Wide Web.

The electronic device, also referred to as a client device, in some instances can be provided as part of the greeting card display, by being mounted on it, mounted near it, tethered thereto, or completely un-mounted and un-tethered. Alternatively, a user can use the user's own device, such as a smart phone, laptop, or tablet device, thereby making the user's device the client device.

The actual purchase can be an electronic purchase using the client device, or the customer can make the purchase from a live person at the location where the display is located.

There can be multiple displays in different locations, such as in first and second different buildings, the first building housing a first display and the second building housing a second display. The system can receive information identifying the location of a user, such as location information provided by smart phones. The user can then be provided with the images of cards at that selected location. This allows for accommodation of out of stock cards at a particular location and allows different locations to be stocked with different cards.

### DRAWINGS

These and other features, aspects, and advantages of the present invention are better understood with reference to the following description, appended claims, and accompanying drawings, where:

FIG. 1 is a front perspective view of a display having features of the present invention, the display being made of three connected cabinets;

FIG. 2 is a rear perspective view of the display of FIG. 1;

FIG. 3 shows one of the cabinets of the display of FIG. 1 exploded, the cabinet comprising a plurality of modules connected together;

FIG. 4 is a perspective view of one of the modules of the display of FIG. 1 showing how it is assembled;

FIG. 4A is a perspective view of a portion of one of the cabinets of the display of FIG. 1 showing how a module can be replaced;

FIG. 5 is a perspective view of a pocket used for forming the modules of FIG. 4;

FIG. 5A is a front elevation view of a greeting card;

FIG. 5B shows an insert that can be used with the display of FIG. 1.

FIG. 6 is a side perspective view of a portion of one of the cabinets of the display of FIG. 1 showing labeling;

FIG. 7 is a perspective view of a display having the feature display of FIG. 1 with the addition of a return device such as a return box;

FIG. 8 is a perspective view of a version of the invention where multiple cabinets are in a four sided display, optionally rotatable;

FIG. 9 is a front plan view of a second version of the display having features of the present invention;

FIG. 10 is a front perspective view of a third version of the display having features of the present invention;

FIG. 11 is a schematic view of a system according to the present invention; and

FIG. 12 is a flow chart of a method utilizing the system of FIG. 11

### DESCRIPTION

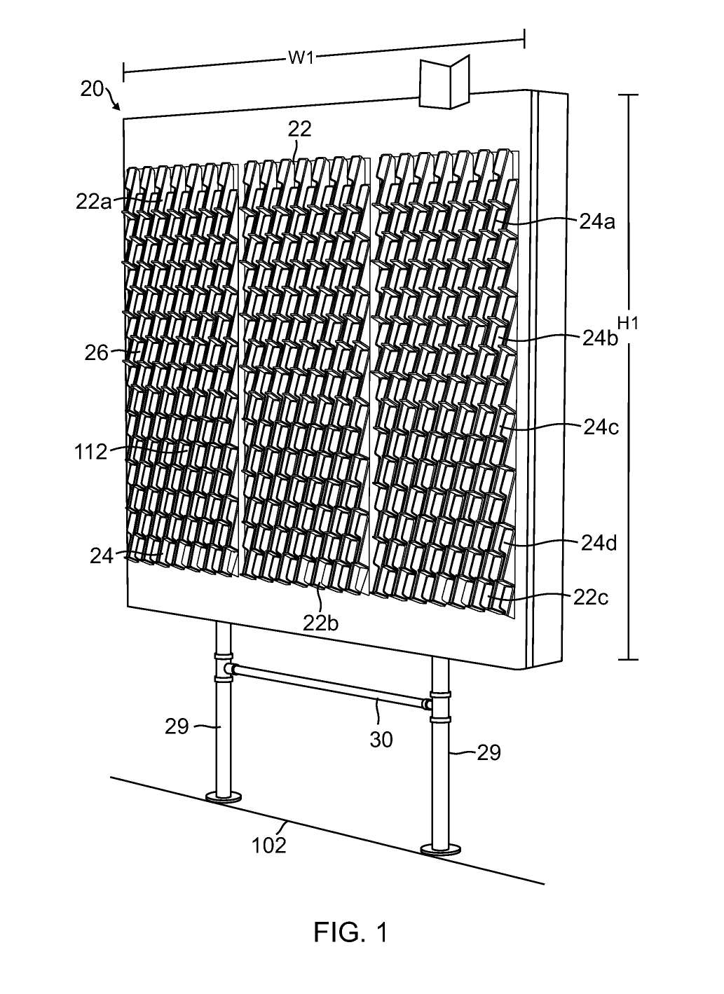

With reference to FIG. 1, a display 20 having features of present invention comprises at least one cabinet 22, preferably multiple cabinets, each cabinet 22 formed from multiple modules 24, each module having a plurality of pockets 26 for holding greeting cards 27. Preferably, as described below, each module is replaceable without having to replace any other module. In the version shown in FIG. 1, there are three side-by-side cabinets, 22a, 22b, and 22c, and each cabinet is formed with four modules, 24a, 24b, 24c, and 24d in a stack. Thus the cabinets 22 are side-by-side, and the modules 24 are stacked one on top of the other. There can be any number of cabinets 22 in the display 20, and any number of modules 24 in a cabinet 22. Different displays can have different number and configuration of cabinets and different cabinets in a single display can have a different number of modules. Moreover, the modules need not be stacked on top of each other in a cabinet. For example, a cabinet can be formed from a plurality of modules side-by-side. Furthermore, individual cabinets within a display do not need to share a wall with other cabinets. For example, an individual display can be formed from a plurality of independent cabinets not sharing walls.

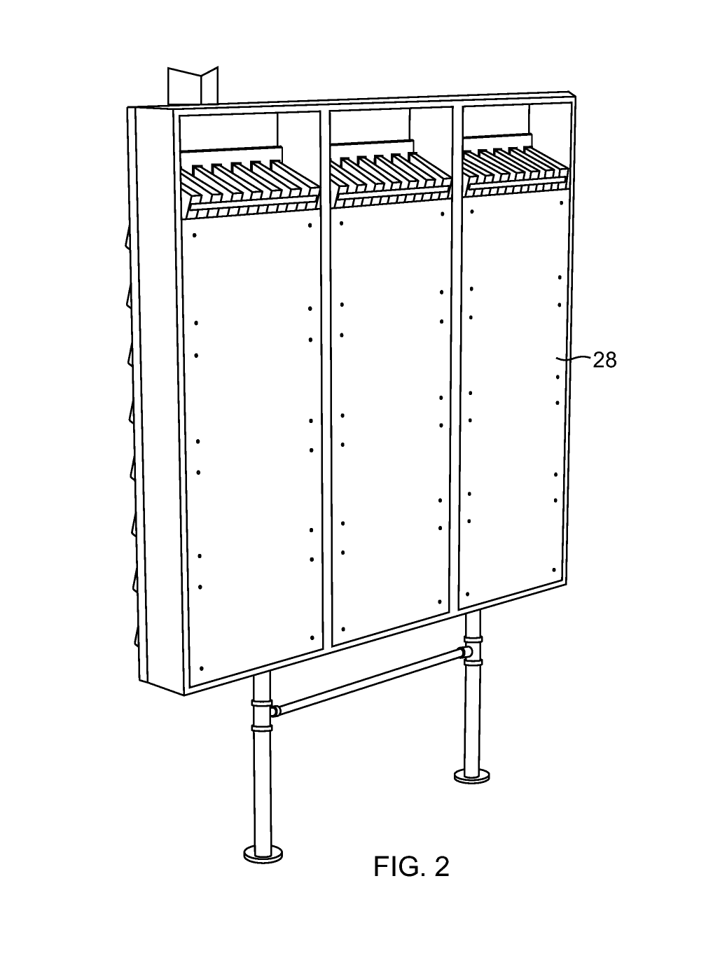

With reference to FIG. 2, the display 20 optionally has a backing sheet 28 such as plywood, which can be secured to a wall or other generally vertically oriented surface. Optionally the cabinets 22 can each be independently mounted to a wall side-by-side. Optionally, as shown in FIG. 1, the display 20 can include floor based supports, such as two vertically oriented pipes 29 reinforced with a crossbar 30.

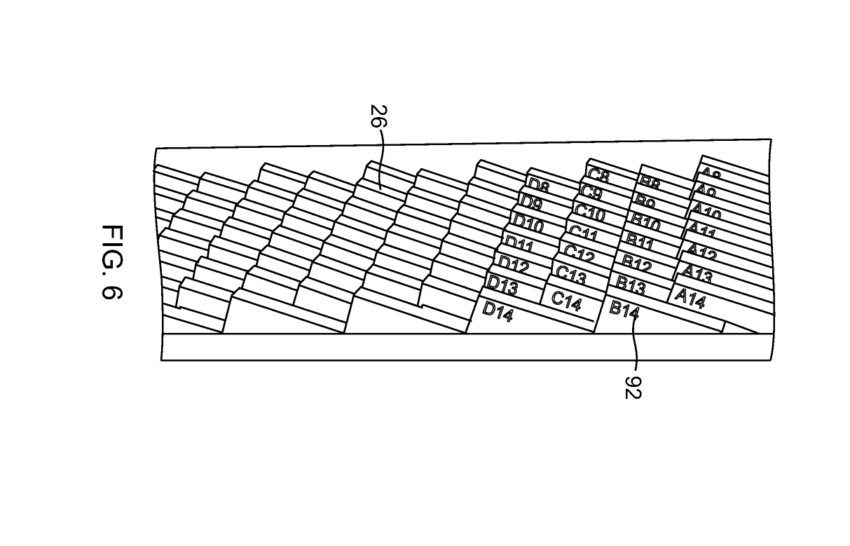

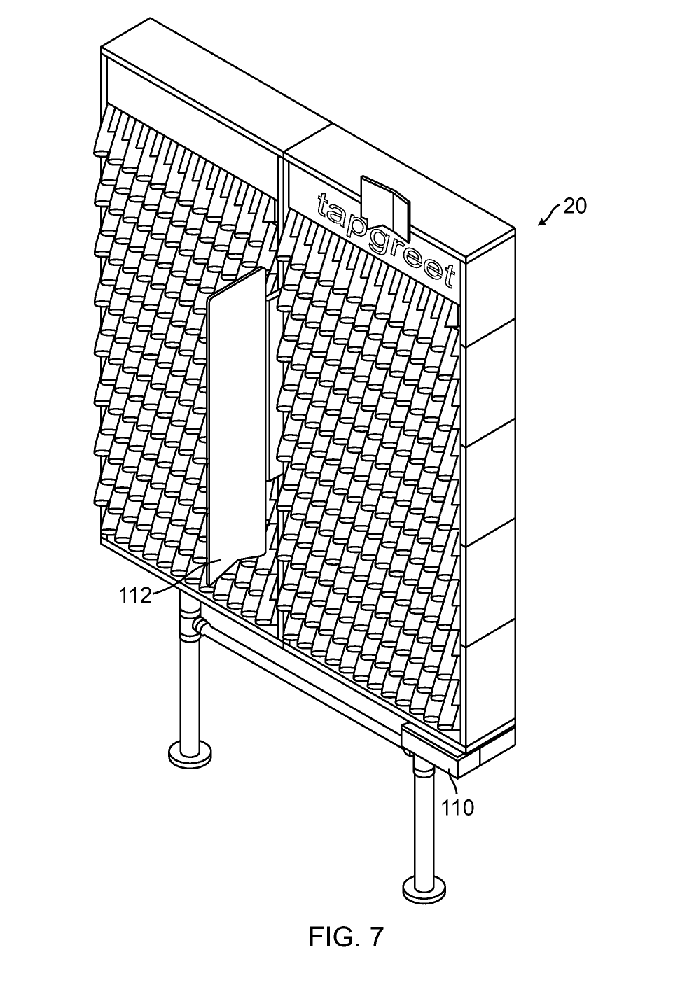

Preferably each module is made up of plurality of pockets 26. As shown in FIGS. 1 and 2, a preferred display 20 has each module having four rows of pockets 26, each row containing seven pockets 26, so that each module can contain 28 different greeting card designs. Thus the display 20 in FIG. 1 has a total of 384 pockets, so up to 336 different greeting card designs and approximately 2,300 total cards can be accommodated in very little floor space. For example, the display of FIG. 1 can be about 63 inches wide, W1, about 60.75 inches tall, H1, and about 7.5 inches deep. Each module can be about 12.25 inches tall, H2, and about 21 inches wide, W2. As shown in FIG. 7, another suitable module design is one where there are four rows, each row containing 12 pockets 26, so that each module can contain 48 different greeting card designs with a width of about 24 inches.

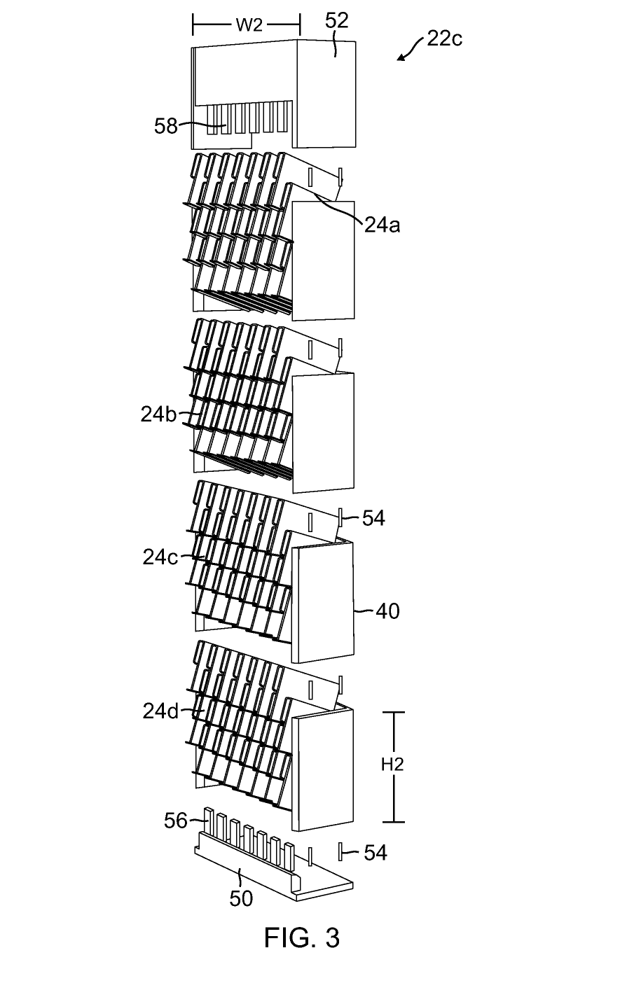

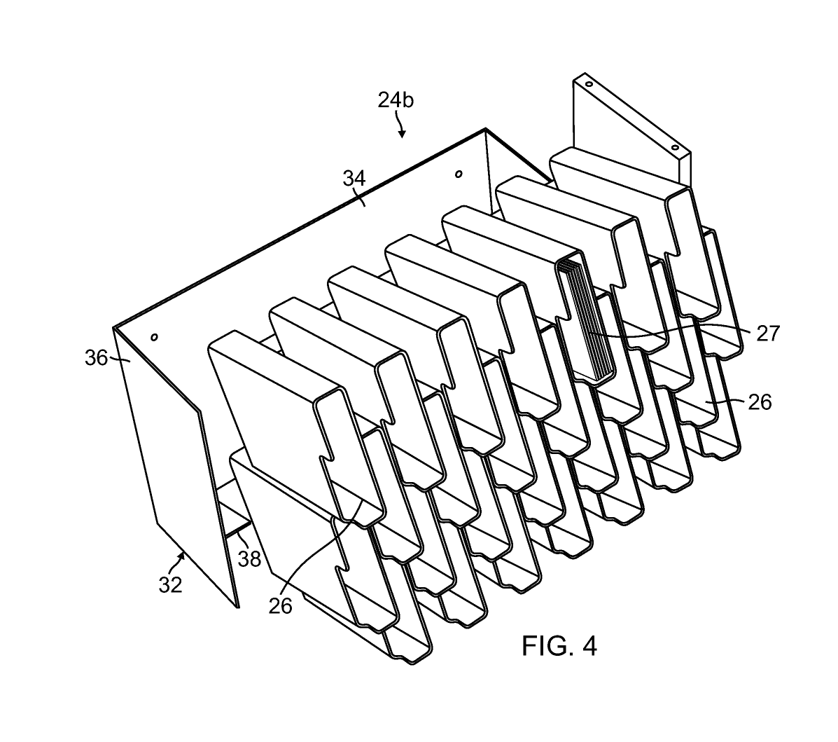

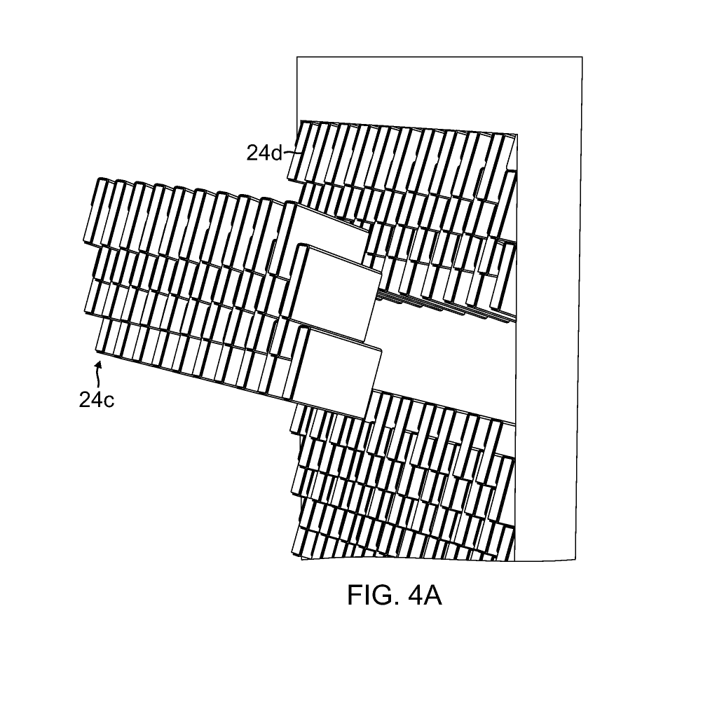

With reference to FIGS. 3 and 4, the pockets 26 are secured together in an assembly, such as in a staggered configuration, using fasteners or preferably an adhesive. The assembled pockets are mounted into a chassis 32, which can be made of steel, which is generally U-shaped with a back 34 and forwardly projecting arms 36, each arm 36 having at least one inwardly facing rail 38 on to which the assembled pockets can slide to be supported. Optionally, the assembled pockets may rest on additional inwardly facing rails protruding from back 34. Preferably an attractive veneer 40 is secured such as with a fastener or adhesive on the outside face of each arm 36 for aesthetic purposes. The modules 24 are assembled together to form the cabinet 22 as shown in FIG. 3, where they are mounted one on top of another, between a bottom base 50 and a top 52, with adjacent modules 24 connected to each other with dowels 54 extending into holes in the adjacent veneers. The base 50 has upwardly projecting pegs 56, which slide between pockets, and likewise the top 52 has downwardly projecting pegs 58 that slide in between the pockets. The dowels can be made of wood or metal or plastic. Due to use of dowels and the pegs, each module is easily removeable. Optionally, the bottom base 50 or the top 52 may be permanently fixed, with or without dowels, to the side veneer pieces used to cover the metal chassis of the module above the bottom base 50 or the module below the top 52. Optionally, the modules 24 can be mounted into chassis 32 that can fit multiple modules. For example, a cabinet 22 can have one metal chassis 32 that supports four modules 24, still with inwardly facing rails 38 for each module 24.

The side veneer pieces can be made out of wood, metal, or any other material, and is generally chosen for the aesthetics.

With reference to FIG. 4A, an advantage of the modular design is that the display can be restocked by replacing a module, such as module 224, with another module. Thus a module can be preloaded at a central location, and then quickly switched out in the field, thereby significantly saving in labor costs. Modules can be replaced as sales of cards reduce the stock, or seasonal cards can be replaced with current cards. For example, once Mother's Day has passed, a module containing Mother's Day cards can be replaced with a module containing Father's Day cards. Similarly when Thanksgiving has passed, a module containing Thanksgiving cards can be replaced with a module containing Christmas and Hanukkah cards.

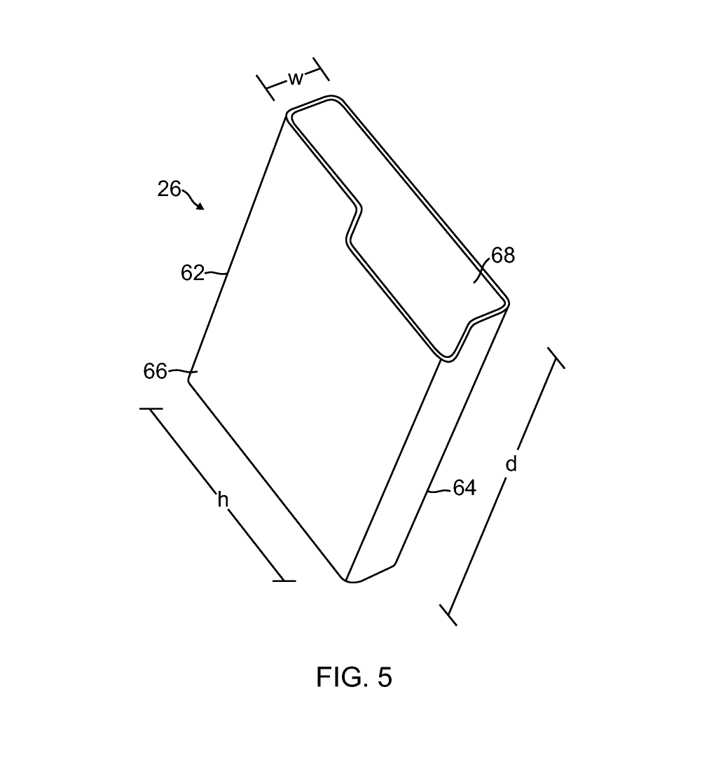

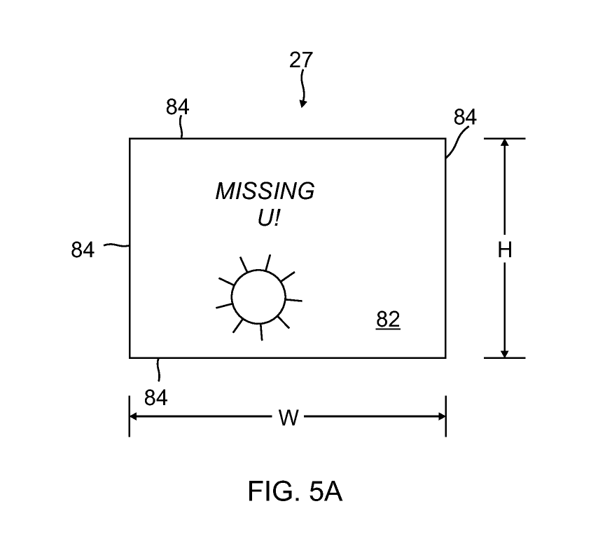

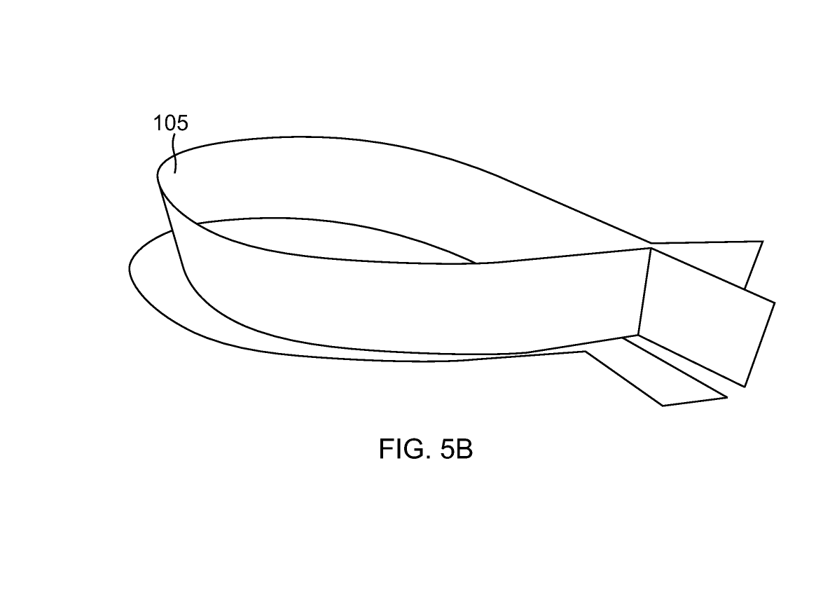

With reference to FIG. 5, each pocket 26 has a top wall 62, a bottom wall 64, opposed side walls 66 and a generally forward facing opening 68. The pockets have a height “h” and a width “w” and a depth “d”. A typical pocket is about 7¾ inches deep, about 5¾ inches in height and has a width of about 1⅜ inches. Another suitable pocket dimension is 7.438 inches deep, 5.688 inches in height, and has a width of 1 inch.

As shown in FIG. 5A, each greeting card have a width “W,” a height “H,” a front face 82, and multiple edges 84. The front face 82 of the card has words, decoration, or both. Unlike conventional greeting card displays, the greeting cards 27 are placed in at least some of the pockets, and preferably in all of the pockets, so that one of the edges 84 faces toward the forward facing opening 68. In this configuration generally no more than 20% of the front face of the cards is visible, and in some instances, none of the front faces of the cards are visible. Typically W is less than H, and generally the width of the greeting cards is greater than at least one of the width and height of the pockets. Stated another way, it is not possible for the typical greeting card to fit in one of the pockets with the front faces of the greeting card facing forwardly.

As shown schematically in FIG. 4, each pocket can contain plurality of greeting cards 27 (only forward edge 84 is shown in FIG. 4).

By the term “greeting card” there is meant a card bearing a sentiment such as a greeting, congratulations, sympathy, love, birthday greeting, or holiday greeting. Typically a greeting card is folded, but the term “greeting card” includes such cards that do not have a fold.

A variety of materials, such as plastic, particularly polystyrene, or cardboard can be used to form the pockets.

As shown by FIG. 6, the pockets can be provided with a location code 92, such as by giving each row a letter, such as A, B, C and giving each in a row a number. Optionally, each pocket can be provided with a physical indicator such as light, typically an LED that can be lit up to indicate that a particular desired greeting card is in a particular pocket.

When the pockets are staggered, as shown in FIG. 4, a portion of each pocket is side-by-side and with another pocket.

Optionally, the pockets can be skewed relative to a horizontal surface such as a floor 102 on which a user is positioned. Thus, if the pockets are skewed, the pockets are aligned on a longitudinal axis that is skewed relative to the horizontal, by about five to about thirty degrees, and preferably by about twenty degrees.

Displays can be supported indirectly on a floor, wall, on a generally vertically oriented post, or a generally horizontally oriented post.

Generally all of the pockets are the same size, although that is not required. All pockets 26 need not have the same configuration. Some can be larger than others or of different configuration to accommodate greeting cards of different shapes and sizes. Optionally, a pocket insert 105, such as shown in FIG. 5B, can be used to lift differing card sizes to generally consistent points relative to the forward facing opening 68.

In an optional version of the invention, the display can be provided with pictures of the various greeting cards along with the location code associated therewith. However, it is preferred that the greeting cards be displayed in a portable electronic device, as described below.

With reference to FIG. 7, the display can be provided with a return box 110 so that a customer, after viewing an actual greeting card, has the option of not purchasing it and returning it in the return box 110. Alternatively, if a customer were to go through the process of purchasing a greeting card and then decided they wanted to return the card in the traditional sense, they could also use this return box 110.

Preferably instructions in how to use the system provided on a pivotable card 112 mounted to the front of display.

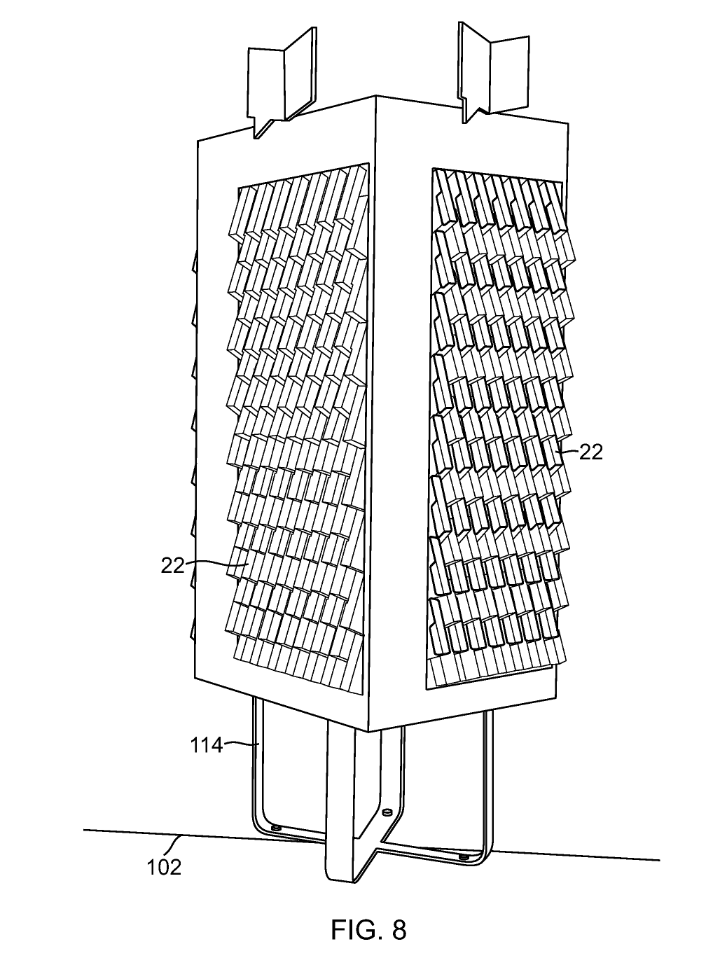

Rather than having the cabinets 22 side by side, they can be provided in a multiple sided configuration, such as a 4-sided rectangular or square configuration in horizontal cross-section, such as shown in FIG. 8, where there are four cabinets 22 supported by a frame 114 on the floor 102. As shown in FIG. 8, a suitable module design is one where there are four rows, each row containing 7 pockets 26, so that each module can contain 28 different greeting card designs.

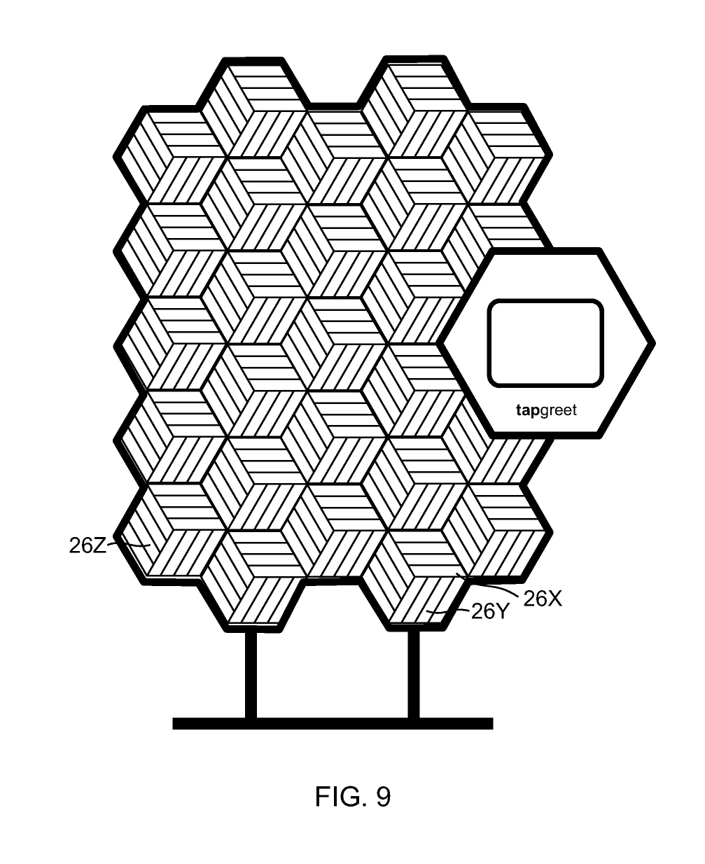

FIG. 9 shows another version of the invention where the pockets are in different orientations. The pockets are grouped so that there are 4 pockets 26X generally horizontally oriented, 4 adjacent pockets 26Y generally vertically oriented, and 4 pockets 26Z oriented generally at right angles to the pockets 26X and 26Y.

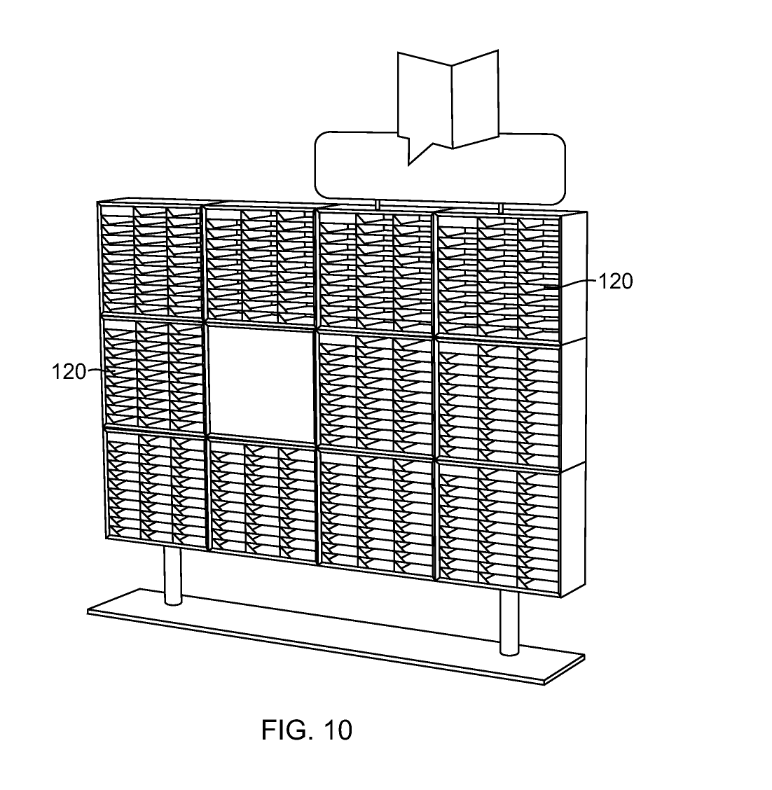

In FIG. 10 the pockets are much like conventional mail slots provided in modules 120, each module having three side-by-side columns of pockets, each column having ten pockets stacked on top of each other.

The reference to “Tapgreet” is to the mark the inventor intends to use for the system.

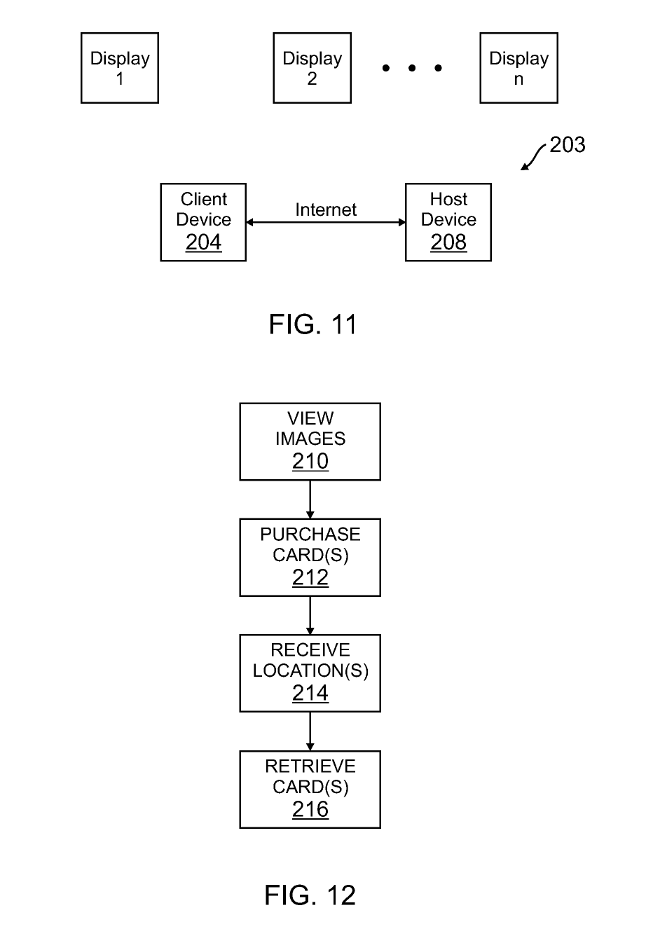

With regard to FIG. 11, this is schematically showing a greeting card system 203 that has multiple displays 20, identified in FIG. 11 as display 1, display 2, . . . display n. Although the invention is useful with just a single display, there can be “n” displays 20 as part of the system, where the displays can be the same or different. Typically the displays are housed in separate spaced-apart buildings, such as various coffee shops, or other retail establishments.

Each display can have associated with it a client device 204. The client device can be any electronic device that has a user display and a user input interface. It can be a computer, smart phone such as an IPhone (Trademark), touch tablet, a reader such as a Kindle brand reader, or the like. In one version of the invention the client device 204 is provided as part of the display, and is preferably attached thereto so it cannot be removed. It can be securely mounted on a display or tethered thereto. The device is loaded with images and locations of the greeting cards in a particular display, and the user can use that for selecting greeting cards. Optionally the client device is connected through the internet to a host device 208, which is typically at a remote location. The host device and the client device are configured to communicate via the internet, such as by connecting the client device via a WiFi connection utilizing new field communications. The host device can be any computer based system that is useful for hosting websites, such as a desk top computer or server. The client device can interact with the host device to effect purchase of a greeting card. Optionally there is no host device, and with use of the client device, customer can identify a greeting card, select from the display, and pay for it with a live person, such as a clerk manning the particular location.

Preferably the client device is a user provided device so that each user/customer has his/her own device. Optionally, a display may, or may not, provide a client device for the user/customer to use, thereby sometimes forcing a user/customer to provide his/her own device.

In a preferred version of the invention, as shown by FIG. 12, a potential customer views images of available greeting cards in a particular display, such as display 20 n, on the client device in step 210. Typically the user has their own client device, and receives the images through the internet from the host device. Optionally an app can be provided for loading on the client device, where the app shows greeting cards, and can be updated as needed through the internet.

After viewing the card in step 210, the customer can purchase one or more selected cards in step 212. Purchases can be effected through credit card transaction, debit card transactions, use of gift cards, or accounts can be set up. An advantage of purchase through the interaction host device is it avoids the need for the retail store hosting the display from being involved in the transaction.

After purchase of the card, the customer then receives the location code of the purchase cards in step 214, and then retrieves the cards from the display by removing them from the display in step 216.

Because there can be multiple displays hosted by a single host device 208, optionally the user can provide an identification number or other designation of a display to the host device so that the client device only shows cards that are associated with the display, and that are in stock. Optionally for smart phones and other devices that provide a location indication, rather than have the user provide the location of the display, the client device can detect location, and automatically provide images of only the cards that are in stock present in that particular display. In addition, for smart phones and other devices that allow for the use of QR Codes, a customer can scan a QR code located on or near a display 20 as a means for easily identifying the location for the purpose of displaying images of only the cards that are stocked presently in that particular display. Each display would have a different QR Code.

The steps shown in FIG. 12 need not be performed in the order shown. For example a location can be provided in step 214 before the purchase is effected in step 212. Thus the user could retrieve the cards in step 216 before their purchasing step 212.

Although the present invention has been described in considerable detail with reference to certain preferred versions thereof, other versions are possible. For example although the present invention has been described with regard to greeting cards, they can be useful for any product that is ordinarily presented to customer with a wide faced forward, where there are inadequate markings on a spine or the like to accurately determine what is being sold. For example it can be used with post cards, magazines, and calendars. Therefore the spirit and scope of the appended claims should not be limited to the description of the preferred versions contained herein.

1. A greeting card display comprising:
a. at least three display pockets, each pocket having a top wall, a bottom wall, opposed side walls, and a generally forwardly facing opening; and
b. at least two greeting cards in at least some of the pockets, the greeting cards having a width, a height, a front face, and an edge, wherein the greeting cards are positioned in the pockets so the edges face toward the forwardly facing opening and so that no more than 20% of the front face of the cards are visible.

2. A greeting card display comprising:
a. at least three display pockets, each pocket having first and second opposed walls, and third and fourth opposed walls, and a generally forward facing opening, the distance between the first and second walls is h and the distance between the third and fourth walls is w; and
b. at least two greeting cards in at least some of the pockets, the greeting cards having a width, a height, a front face, and an edge, the width of at least some of the cards being less than or equal to the height of the greeting cards and greater than at least one of w and h, wherein the greeting cards are positioned in the pockets so the edges face toward the forward facing opening.

3. The display of claim 2 wherein the greeting cards are positioned in the pockets so that no more than 20% of the front face of the cards are visible.

4. The display of claim 1 wherein substantially none of the front faces of the cards is visible.

5. The display of claim 1 wherein the pockets are labeled with a location code.

6. (canceled)

7. The display of claim 1 supported for access by a user positioned on a generally horizontal surface, and wherein the pockets have a longitudinal axis skewed relative to the horizontal surface.

8-10. (canceled)

11. The display of claim 1 supported on a generally horizontally oriented post.

12. (canceled)

13. The display of claim 1 wherein at least two pockets are the same size and have only a portion of each side-by-side with each other.

14. A greeting card distribution system comprising:
a. the greeting card display of claim 5; and
b. an internet accessible web site displaying images of the greeting cards, at least some of the greeting cards having associated with them the corresponding location code.

15. (canceled)

16. A greeting card distribution system comprising:
a. the greeting card display of claim 5; and
b. a software application usable by an electronic device having an input interface and a display, the application being able to enable the electronic device to display images of the greeting cards, at least some of the greeting cards having associated with them the corresponding location code.

17. (canceled)

18. The system of claim 16 wherein the application allows purchase of the greeting card.

19. A greeting card distribution system comprising:
a. the greeting card display of claim 5; and
b. an electronic device having an input interface and a display, the device enabled to display images of the greeting cards, at least some of the greeting cards having associated with them the corresponding location code.

20. (canceled)

21. A method of distributing greeting cards comprising the steps of:
a. providing the system of claim 14;
b. receiving a request to purchase at least one greeting card in the display;
c. providing the location code of the requested greeting card; and
d. processing the purchase request.

22. A method of distributing greeting cards comprising the steps of:
a. providing the system of claim 14;
b. receiving a communication from a user; and
c. providing the location code of at least one greeting card to the user.

23-24. (canceled)

25. A method of purchasing a greeting card comprising the steps of:
a. accessing the web site of the distribution system of claim 14;
b. viewing images of greeting cards at the accessed web site;
c. purchasing a greeting card;
d. receiving the location code; and
e. removing the greeting card from the pocket corresponding to the location code.

26-28. (canceled)

29. The method of claim 25 wherein the step of purchasing comprises paying consideration to a live person.

30. (canceled)

31. A method of purchasing a greeting card comprising the steps of:
a. downloading the software application of claim 16 and installing it on an electronic device;
b. after step (a) viewing images of greeting cards on the display of the electronic device;
c. purchasing a greeting card;
d. viewing the location code on the display of the electronic device of the purchased greeting card; and
e. removing the greeting card from the pocket corresponding to the location code.

32-35. (canceled)

36. A method of purchasing a greeting card comprising the steps of:
a. viewing images of greeting cards on the electronic device of the system of claim 19;
b. receiving the location code of at least one greeting card on the electronic device; and
c. removing the greeting card from the pocket of the display of claim 19 corresponding to the location code.

37. A greeting card system comprising:
a. a display having at least one removable installed module, the installed module having a plurality of pockets for holding greeting cards; and
b. a replacement module having the same size and configuration as the removable installed module, the replacement module not being installed and having a plurality of pockets preloaded with greeting cards, and wherein upon removal of the installed module from the display, the replacement module can replace the installed module.

38. A greeting card distribution method comprising the steps of:
a. providing the system of claim 37;
b. removing the installed module from the display; and
c. replacing the removed module with the replacement module.

39. (canceled)

40. A method of distributing greeting cards comprising the steps of:
a. providing the system of claim 13 with at least first and second displays, the first display being in a first building and the second display being in a second building, the first and second buildings being different;
b. receiving information identifying the first or second display;
c. receiving a request for the location of at least one greeting card in the identified display; and
d. providing the location code of the requested greeting card.

41. (canceled)

42. The display of claim 1 having a first pocket with a first greeting card therein and a second pocket with a second greeting card therein, the first and second greeting cards being of different size, and wherein one of the first and second pockets contains an insert so that the first and second greeting cards extend forwardly in their respective pockets by about the same amount.
